(19) United States
(12) Patent Application Publication
(10) Pub. No.: US 2019/0392399 A1
(43) Pub. Date: Dec. 26, 2019

(54) STATE-BASED ELECTRONIC EVENT PROCESSING SYSTEM

(71) Applicant: You Blossom, Inc., Orem, UT (US)

(72) Inventor: Ryan Horne, Orem, UT (US)

(21) Appl. No.: 16/015,793

(22) Filed: Jun. 22, 2018

(51) Int. Cl. G06Q 10/10

(52) U.S. Cl. CPC G06Q 10/1095; G06Q 50/01

(57) ABSTRACT

A system may include processing logic configured to execute instructions to cause a system to perform operations to provide a graphical interface for creating an event, receive, via the graphical interface, event input to create the event, including an invitee and a threshold number of invitees that can accept the invitation to the event, cause an electronic invitation to the event to be sent to a client device associated with the invitee, receive a notification indicative of an acceptance of the electronic invitation to the event, and display, via the graphical interface, that the threshold number of invitees have accepted the invitation to the event.

### FIELD

The embodiments discussed herein are related to a state-based electronic event processing system.

### BACKGROUND

Computers may be used to perform operations that humans cannot do. Computer technology is constantly evolving because new problems are routinely discovered as technology advances. Many issues rooted in technology may stand in the way of technological progress.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example network architecture in which embodiments of the present disclosure may be implemented;

FIGS. 2A and 2B illustrate an example GUI for browsing one or more events in accordance with aspects of the present disclosure;

FIGS. 3A, 3B, 3C, 3D, 3E illustrate example GUIs for viewing an electronic invitation to an event;

FIGS. 4A, 4B, 4C, 4D, 4E illustrate example GUIs for initiating or creating an event;

FIGS. 5A, 5B, and 5C illustrate example GUIs for managing an event;

FIG. 6 illustrates a flow diagram of an example method to create an event;

FIG. 7 illustrates a flow diagram of another example method to handle a cancellation of an acceptance to an event;

FIG. 8 illustrates a flow diagram of another example method 80 to handle a request to create an event;

FIG. 9 illustrates a flow diagram of an example method 900 to receive an electronic invitation to an event; and

FIG. 10 illustrates a diagrammatic representation of a machine in the example form of a computing device within which a set of instructions, for causing the machine to perform any one or more of the methods discussed herein, may be executed,

all arranged in accordance with at least one embodiment described herein.

### DESCRIPTION OF EMBODIMENTS

One of the problems facing the designers of computing devices is how to allow the user to navigate quickly and efficiently to access data and activate and deactivate a desired function. For example, using a conventional computer system, a user may send an invitation message to multiple friends asking if they want to participate in an activity or event, such as going boating on a local lake. The boat may have a limited number of seats so, when using conventional computers systems, a user may send the invitation message to a number of friends up to the total number of seats available on the boat. When some of those friends user their devices to decline the invitation, the user may then send out more messages to other friends asking if they want to go boating. As more friends decline the invitation, the user may iteratively follow this process. Doing so may be time consuming and may be prone to technology-based errors, such as emails that are sent to a junk folder, or in text messages that fail to send or receive, among many other technology-based problems.

Additionally, sometimes messages are delayed when sent or received. In this case, thinking that it has been a while since sending an invitation message to a friend with no response, the user may invite another friend. Later, however, both friends may receive the invitation message and both may accept. Because of these and other problems with conventional technology, the user may end up with more friends showing up to go boating than there are available seats in the boat. This may leave the user in an awkward situation of having to tell one friend that there actually is no room for them. Because of conventional systems, it may be difficult to efficiently and accurately coordinate an event.

Aspects of the present disclosure address these and other problems with conventional systems by providing a state-based electronic event processing system. The disclosed embodiments relate to a computing system with improved techniques for providing, generating and displaying user interfaces. In at least one embodiment, a user (e.g., an event creator) can use the described technology to initiate the creation of an event. Computing systems may send invitations to the event to any number of people, including a number larger than the number of attendees that can attend the event—such as more people than can fit in the boat of the above example. When creating the event, the event creator may designate a maximum number of invitees that may attend the event. Once the event is full, i.e. once the set maximum number of invitees have accepted the invitation to the event, the systems described herein can prevent any other attendees from using their respective user devices to accept the event. For example, when the event creator posted the event invitation in a social network, the systems described herein can, automatically and without any additional input from the event creator, remove the post in the social network, make the post private, or any other mechanism to prevent any further invitees from accepting the invitation to the event.

Techniques described herein thus provide improvements to existing computer systems by providing a temporal event invitation that may seemingly disappear (at least from an invitee's perspective).

In a specific example, the systems described herein can be used for significantly reducing friction in event creation and planning and may increase speed (significantly) in matching events with people who may be interested in the events and may not otherwise know about the events. In at least one embodiment, an event creator may create an event and create one or more custom or preset responses to make it easier for the other users (e.g., invitees) to respond with just a double tap or touch of a button, link, icon, etc. When another user (e.g., an invitee) chooses one of the preset responses, then the systems described herein may automatically notify both users of the connection or match for that response. The response may be automatically recorded and organized for both users. This information may also automatically go into a calendar (or other) that each user can see and where the users can communicate.

Embodiments of the present disclosure are explained with reference to the accompanying drawings.

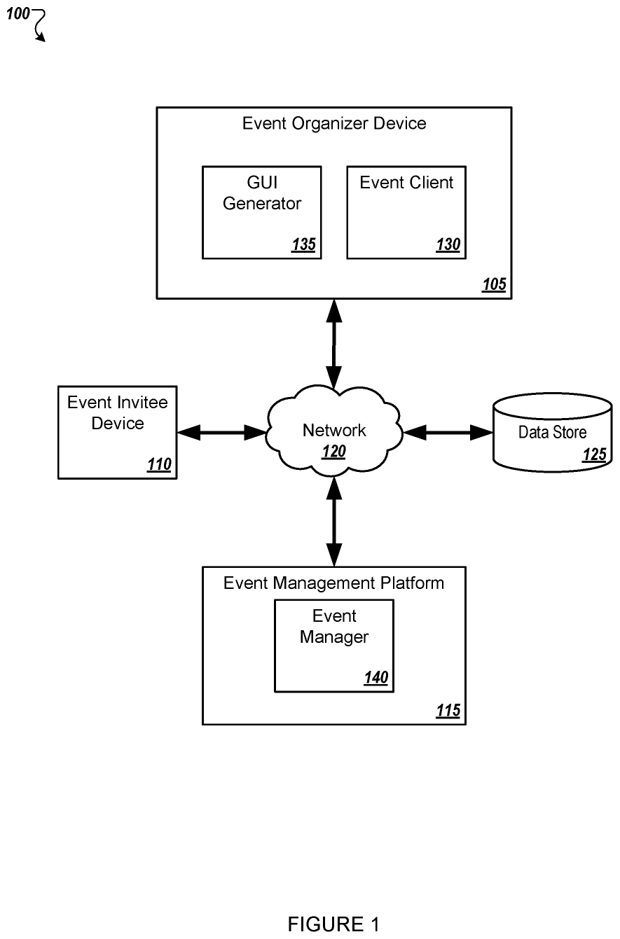

FIG. 1 illustrates an example network architecture 100 in which embodiments of the present disclosure may be implemented. The network architecture 100 may include an event organizer device 105, an event invitee device 110, and an event management platform 115. In some embodiments, the network architecture 100 may be capable to move data between event organizer device 105, the event invitee device 110, and the event management platform 115 via a network 120.

The event organizer device 105 may include a computing device such as personal computer (PC), laptop, mobile phone, smart phone, tablet computer, netbook computer, e-reader, personal digital assistant (PDA), or cellular phone, etc. While only event organizer device 105 is illustrated in FIG. 1, network architecture 100 may include any number event organizer devices 105. Further, in at least some embodiments, an event organizer device 105 may function as an event invitee device 110 and the event invitee device 110 may function as an event organizer device 105. The event organizer device 105 may be configured to provide a user interface, such as via an application, that allows a user to create, manage, and modify events.

The event invitee device 110 may include a computing device such as personal computer (PC), laptop, mobile phone, smart phone, tablet computer, netbook computer, e-reader, personal digital assistant (PDA), or cellular phone, etc. While only event invitee device 110 is illustrated in FIG. 1, network architecture 100 may include any number event invitee devices 110. The event invitee devices 110 may be configured to provide a user interface, such as via an application, that allows a user to browse events, receive invitations to event, accept invitations to events, cancel accepted invitations, message others about the events, and receive any other information pertaining to one or more events.

The event management platform 115 may include one or more computing devices, such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components.

The network 120 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network), routers, hubs, switches, server computers, and/or a combination thereof.

The event management platform 115 may be communicatively coupled to a data store 125. The data store 125 may include any memory or data storage. The data store 125 may include network communication capabilities such that other components in the network architecture 100 may communicate with the data store 125. In some embodiments, the data store 125 may include computer-readable storage media for carrying or having computer-executable instructions or data structures stored thereon. The computer-readable storage media may include any available media that may be accessed by a computer, such as a processor. For example, the data store 125 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a computer. Combinations of the above may be included in the data store 125. The data store 125 may store various data. The data may be stored in any data structure, such as a relational database structure. For example, the data store 125 may include user account data, event data, etc. The data store 125 may include computer-readable storage media that may store computer-executable instructions to perform any method or operations described herein.

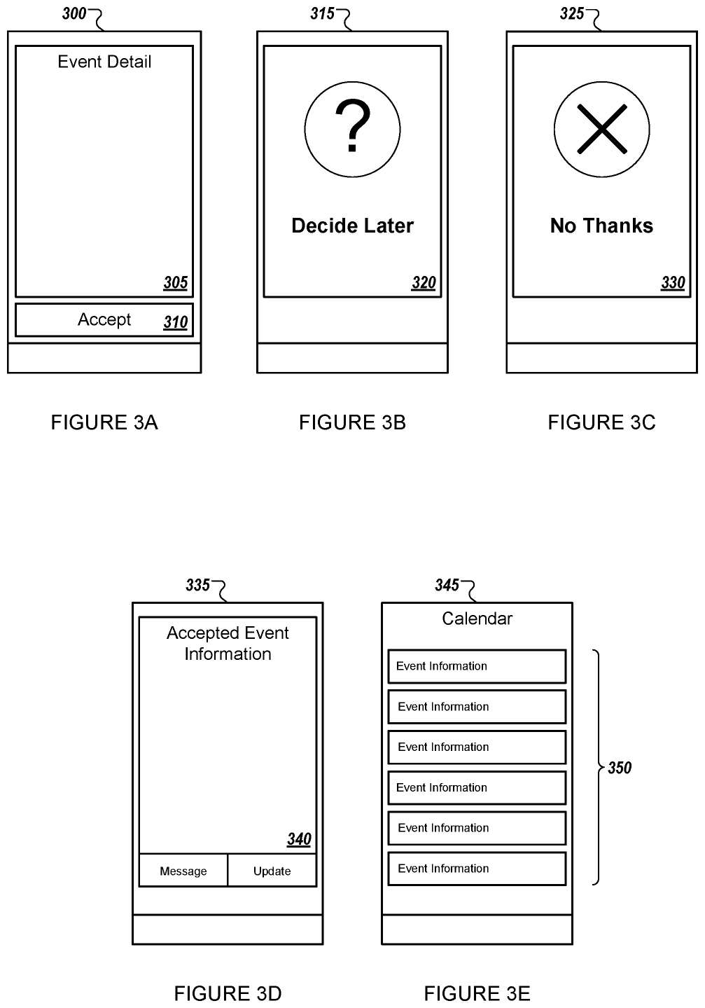

The event organizer device 105 may include a GUI generator 135. The GUI generator 135 may present one or more user interfaces pertaining to creating, editing, modifying, and sending electronic invitations. In an example, the GUI generator 135 may present and/or display a GUI within a web browser. Some example GUIs include interface elements in the form of a button (e.g., a button for selecting preset event features, a button for selecting an invitee to the event, a text field for receiving information pertaining to the event). However, it should be noted that various other control elements can be used for selection by a user such as a check box, a link, or any other user interface elements. Example GUIs may include a search tool (e.g., to search for an invitee), an upload tool (e.g., to upload a new media item to an event management platform), a menu (e.g., to navigate to different GUIs of the event management platform), a user identifier, and a settings tool (e.g., to configure settings of GUIs of the event management platform), etc. Example GUIs that can be presented by the GUI generator 135 are further described in conjunction with FIGS. 3A, 3B, 3C, 3D, 3E, 3F, 4A, 4B, 4C, 4D, 4E, 5A, 5B, and 5C.

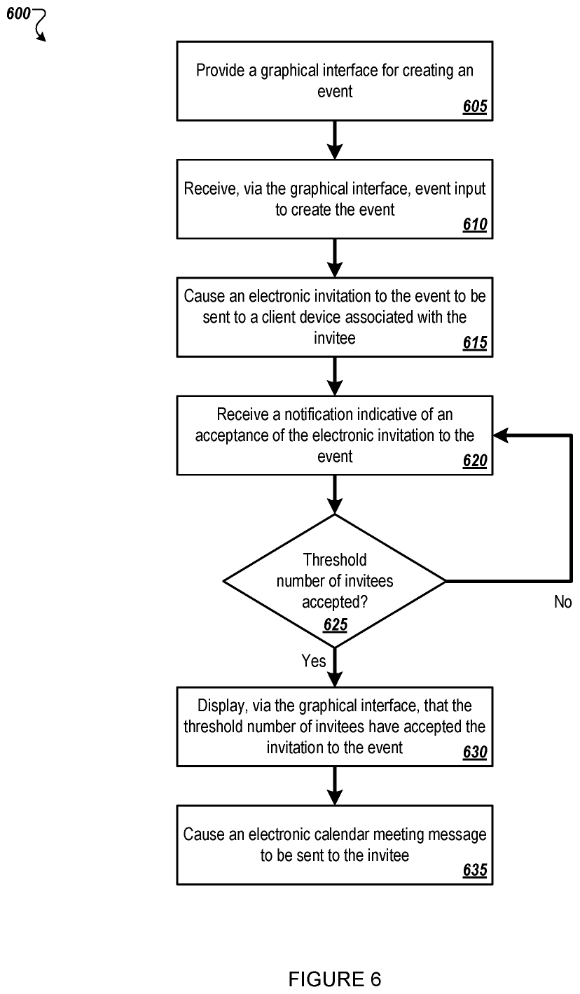

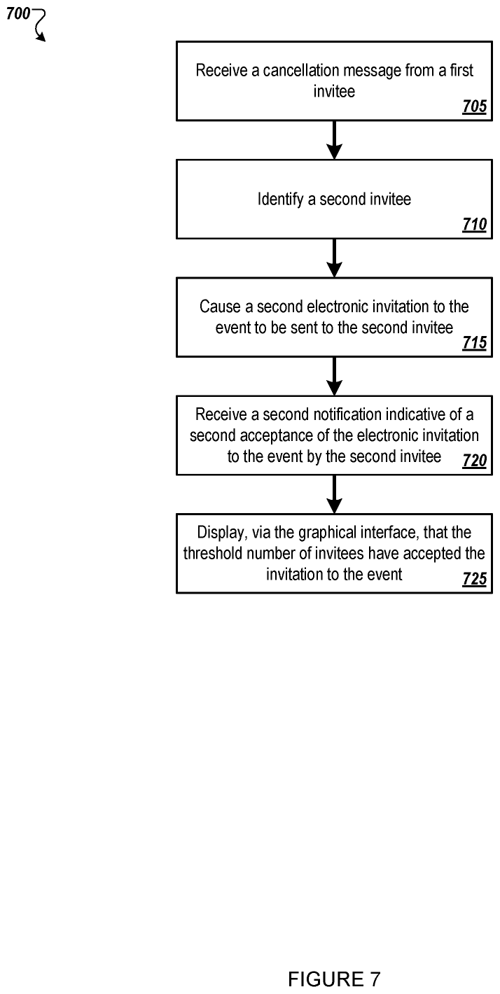

The event organizer device 105 may include an event client 130. The event client 130 may be implemented using hardware including a processor, a microprocessor (e.g., to perform or control performance of one or more operations), an FPGA, or an ASIC. In some other instances, the event client 130 may be implemented using a combination of hardware and software. Implementation in software may include rapid activation and deactivation of one or more transistors or transistor elements such as may be included in hardware of a computing system (e.g., the event organizer device 105). Additionally, software defined instructions may operate on information within transistor elements. Implementation of software instructions may at least temporarily reconfigure electronic pathways and transform computing hardware. The event organizer device 105 may drive the GUI generator 135 such as by sending instructions to the GUI generator 135 to display certain features. The event organizer device 105 may handle creation of new events, modifications of existing events, etc. and may communicate with an event manager 140 of the event management platform 115 via the network 120. Example operations that may be performed by the event organizer device 105 are described in conjunction with FIGS. 6 and 7.

The event management platform 115 may include the event manager 140. The event manager 140 may be implemented using hardware including a processor, a microprocessor (e.g., to perform or control performance of one or more operations), an FPGA, or an ASIC. In some other instances, the event manager 140 may be implemented using a combination of hardware and software. Implementation in software may include rapid activation and deactivation of one or more transistors or transistor elements such as may be included in hardware of a computing system (e.g., the event management platform 115). Additionally, software defined instructions may operate on information within transistor elements. Implementation of software instructions may at least temporarily reconfigure electronic pathways and transform computing hardware. The event manager 140 may communicate between devices associated with event creators (e.g., the event organizer device 105) and devices (e.g., event invitee device 110) associated with invitees of events created by the event creators.

In an example operation of the components of the network architecture 100, the event organizer device 105 may provide a graphical interface for creating an event, such as via the GUI generator 135. The graphical interface may include one or more interface elements configured to receive input pertaining to the event. The input pertaining to the event may include a threshold number of invitees that can accept an invitation to the event. The threshold number of invitees may be predetermined or may be selected by the creator. The event organizer device 105 may receive, via the graphical interface, event input to create the event. The event input may include an invitee and the threshold number of invitees that can accept the invitation to the event.

In response to receiving the event input to create the event, the event organizer device 105 may cause an electronic invitation to the event to be sent to a client device associated with the invitee. For example, the event organizer device 105 may send a request to the event management platform 115 to create the event.

The event management platform 115 may receive the request to create an event from the event organizer device 105. The request may include input pertaining to the event. The input pertaining to the event may include an identification of at least one invitee and a threshold number of invitees that can accept an invitation to the event. The event management platform 115 may create the event with the threshold number of invitees that can accept the invitation to the event. The event management platform 115 may create a record of the event and store the record of the event and information pertaining to the event in a data storage. The event management platform 115 may send an electronic invitation to the event to a client device associated with the invitee (e.g., the event invitee device 110).

The event invitee device 110 may receive the electronic invitation to the event. The event invitee device 110 may provide information pertaining to the event in a graphical interface. The information pertaining to the event may include a user interface element configured to receive an acceptance of an invitation to join the event. The event invitee device 110 may receive an acceptance of the invitation to join the event and may send the acceptance of the invitation to join the event to the event invitee device 110 or the event management platform 115.

The event management platform 115 may receive a notification indicative of an acceptance of the electronic invitation to the event from the event invitee device 110. The event management platform 115 may determine that the threshold number of invitees that can accept the invitation to the event has been met. In at least one embodiment, the acceptance of the electronic invitation to the event from the event invitee device 110 may be the last acceptance needed to meet the threshold number of invitees that can accept the invitation to the event. In at least one embodiment, the event management platform 115 may record all acceptances of invitations to the event in the data store 125 in a record associated with the event. To determine whether the threshold number of invitees that can accept the invitation to the event has been met, the event management platform 115 may query the data store 125 to check the record associated with the event for the number of recorded acceptances. When the threshold number of invitees that can accept the invitation to the event has been met, the event management platform 115 may send a message to the event invitee device 110 to refrain from providing the electronic invitation. For example, the event invitee device 110 may refrain from providing the electronic invitation to the event by stopping a presentation of the electronic invitation in a graphical interface, by deleting the electronic invitation from the event invitee device 110, by disabling or deactivating an interface element that otherwise would permit the invitee to accept the electronic invitation, etc.

In at least one embodiment, the event invitee device 110 may receive, from another device (e.g., the event invitee device 110 or the event management platform 115), an indication that the event is full. The event invitee device 110 may prevent the user interface element configured from receiving the acceptance of the invitation to join the event.

The event management platform 115 may send notification indicative of acceptances of the electronic invitation to the event. For example, when an invitee accepts the electronic invitation to the event, the event invitee device 110 may send the acceptance to the event management platform 115. The event management platform 115 may in turn send the acceptance of the electronic invitation to the event organizer device 105. The event organizer device 105 may receive a notification indicative of an acceptance of the electronic invitation to the event. The event organizer device 105 may display, via a graphical interface, an indication of the acceptance of the electronic invitation to the event. The event organizer device 105 may also display, via a graphical interface, that the threshold number of invitees have accepted the invitation to the event.

In an example, when an event creator creates an event, that user has the ability to create as many responses for that post as desired, customize what the content of each response is and then choose desired number of acceptances (or supply) for each response. When the number of acceptances for each individual response is matched, then that response may disappear and when all of the responses disappear then the entire post will disappear from anywhere that post was sent to (e.g., a feed, a message, a message board, etc.).

When determining acceptances for an event, the event creator may choose any number from one to infinity as desired by that event creator for the number of desired acceptances for the event. In at least one embodiment, when infinity is chosen, then the event or invitations to the event may not disappear based on the number of acceptances and may disappear based on a lapse of time.

After the event invitations disappears from any feed or message, information about the event may still exist for the event creator and for those invitees who were able to accept the electronic invitation. For example, information of the event may exist in the calendar of the event creator and those that accepted the electronic invitation.

When an event is created it can be designated an activity, event, task, schedule, date, group date, group activity, one on one, etc. to make it easier for other users to search for the type of event they are looking for and to share “intent” with other users.

Modifications, additions, or omissions may be made to the network architecture 100 without departing from the scope of the present disclosure. The present disclosure more generally applies to the network architecture 100 including one or more event organizer devices 105, one or more event invitee devices 110, one or more event management platforms 115, one or more networks 120, one or more data stores 125, or any combination thereof.

Moreover, the separation of various components in the embodiments described herein is not meant to indicate that the separation occurs in all embodiments. In addition, it may be understood with the benefit of this disclosure that the described components may be integrated together in a single component or separated into multiple components.

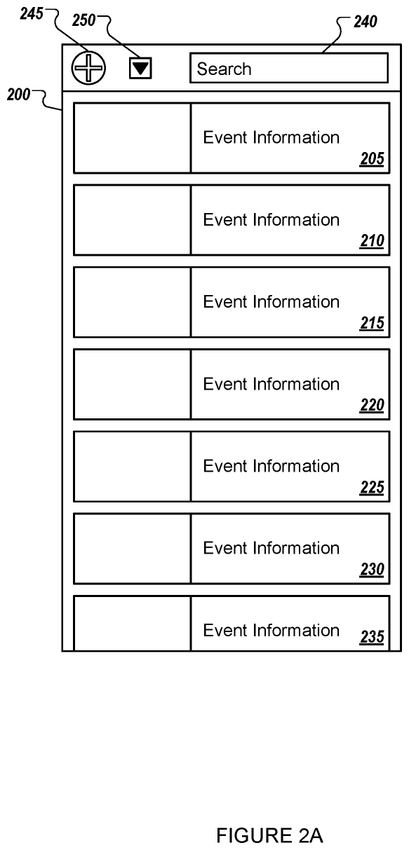

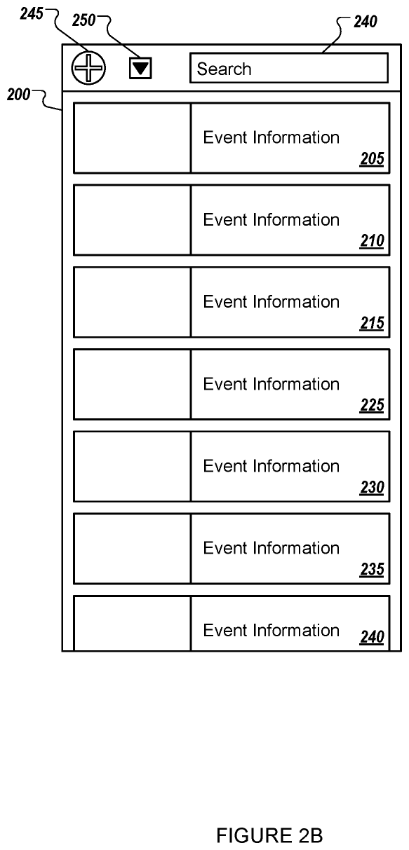

FIGS. 2A, 2B, 3A, 3B, 3C, 3D, 3E, 4A, 4B, 4C, 4D, 4E, 5A, 5B, and 5C illustrate example graphical user interfaces (GUI) in accordance with embodiments. The example GUIs may be presented by and/or displayed within a web browser when a user accesses an event management platform via a web browser. In another embodiment, the example GUIs may be an interface presented by a GUI generator (e.g., an app, an application, a program, a software module/component, etc., that may be used to perform any actions related to an event). Some example GUIs include control elements in the form of a button (e.g., a button for accepting an electronic invitation to an event). However, it should be noted that various other control elements can be used for selection by a user such as a check box, a link, or any other user interface elements.

FIG. 2A illustrates an example GUI 200 for browsing one or more events in accordance with aspects of the present disclosure. The example GUI 200 may present any number of events. The events may include electronic invitations to events, such as electronic invitations to events initiated by the event organizer device. As illustrated, the example GUI 200 includes event information elements for multiple events—event information element 205, event information element 210, event information element 215, event information element 220, event information element 225, event information element 230, and event information element 235. Each of the event information elements may be selectable, such as by a click, a tap, a press, etc. When a particular event information element is selected, additional options may be available, such as an option to obtain more information pertaining to the event, to message one or more other users associated with the event, to accept an invitation to join the event, etc. Upon activation of an event information element, the GUI may transition to an event invitation interface, such as any of the example GUIs illustrated in FIGS. 3A, 3B, 3C, 3D, and 3E.

The example GUI 200 may also include a search tool 240, where a user can search for various events. The example GUI 200 may also include a filter tool 250 that a user can select to filter various events. Example filter criteria may include location, relationship between the user and other users, time, type of event, type of activity, whether other social connections have created or joined an event, etc.

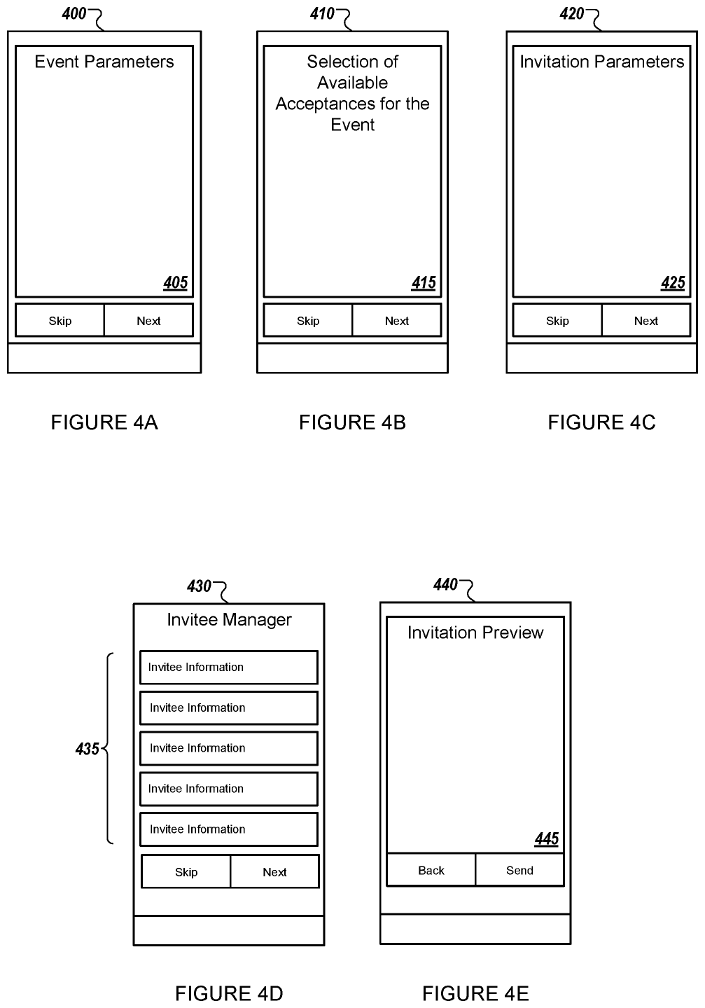

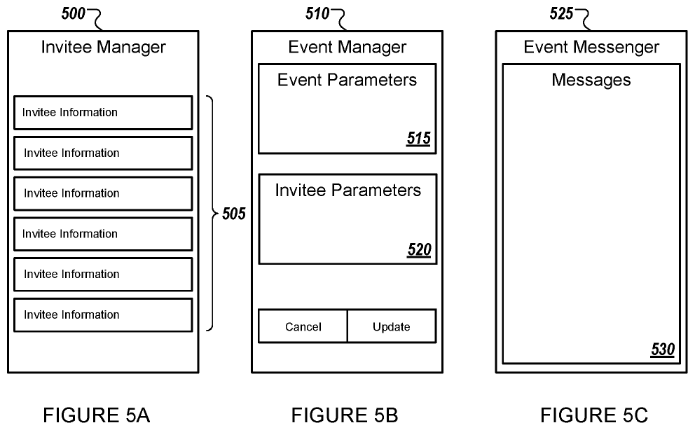

The example GUI 200 may also include an event creator tool 245. The event creator tool 245 may include any type of button, selectable icon, etc. Upon activation of the event creator tool 245, the GUI may transition to an event creation interface, such as any of the example GUIs illustrated in FIGS. 4A, 4B, 4C, 4D, 4E, 5A, 5B, and 5C.

FIG. 2A illustrates the example GUI 200 after one of the events has become unavailable. As illustrated, the event associated with the event information element 220 is not available to the user (or user account) that is currently viewing the GUI 200. Accordingly, the GUI 200 in FIG. 2B does not include the event information element 220.

FIGS. 3A, 3B, 3C, 3D, 3E illustrate example GUIs for viewing an electronic invitation to an event. The example GUIs in FIGS. 3A, 3B, 3C, 3D, 3E may be generated and/or presented by a GUI generator of the event invitee device 110 of FIG. 1.

FIG. 3A illustrates an example GUI 300 for viewing a particular electronic invitation to an event. The example GUI 300 may be displayed in response to receiving a selection of an event information element, such as any of the event information elements of FIGS. 2A and 2B. The example GUI 300 includes event detail 305 and an accept element 310.

The event detail 305 may include any information pertaining to the event, such as information about the type of event (e.g., a date, group date, group activity, “the more the merrier,” a task, a schedule, etc.), a start time, an end time, a location, a picture, who may receive or view the electronic invitation to the event (e.g., a friend, group/groups, everyone (i.e., public), a particular network, etc.), if there will be a group message or feed for others who have accepted the electronic invitation, whether other user may be invited to the event (e.g., a plus 1, 2, 3, etc.).

The accept element 310 may include a graphical element that is configured to receive input indicative of an acceptance of the event. In at least one embodiment, the electronic invitation may be accepted in ways different than through the accept element 310. For example, action may be taken with respect to the electronic invitation by an invitee, using gestures (e.g., a touch on a touch screen, a touch and hold, a swipe, etc.)

FIG. 3B illustrates an example GUI 315 that has transitioned from the example GUI 300 of FIG. 3A in response to a user gesture on a touch screen. For example, the user may swipe in any direction (e.g., up, down, left, right, diagonal) to activate a “decide later” function. The “decide later” function may enable a user to save or mark a particular electronic invitation for viewing at a later time. The example GUI 315 may indicate that the “decide later” function has been activated by displaying a “decide later” message 320 on the example GUI 315. In at least one embodiment, in response to the user activating the “decide later” function, the example GUI 315 may display event details for a different event (not illustrated in FIG. 3B).

FIG. 3C illustrates an example GUI 325 that has transitioned from the example GUI 300 of FIG. 3A (or from the example GUI 315 of FIG. 3B) in response to a user gesture on a touch screen. For example, the user may swipe in any direction (e.g., up, down, left, right, diagonal) to activate a “decline” function. The “decline” function may enable a message to be sent to an event organizer device (e.g., the event organizer device 105 of FIG. 1) or to an event management platform (e.g., the event management platform of FIG. 1). The example GUI 325 may indicate that the “decline” function has been activated by displaying a “decline” message 330 on the example GUI 315. In at least one embodiment, in response to the user activating the “decline” function, the example GUI 325 may display event details for a different event (not illustrated in FIG. 3C).

FIG. 3D illustrates an example GUI 335 that displays accepted event information 340. The example GUI 335 may be displayed after a user selects an acceptance of the electronic invitation. The example GUI 335 may also include a message button and update button. By activating the message button, the example GUI 335 may transition to a messaging GUI (e.g., the event messenger GUI 525 of FIG. 5) where one or more invitees may communicate with the creator of the event and/or with other invitees. The update button may include a mechanism by which a user can update their response to the electronic invitation. For example, using the update button, a user can rescind or cancel their acceptance of the electronic invitation for the event.

FIG. 3E illustrates an example GUI 345 of a calendar of accepted electronic invitations for events. Event information elements 350 for each of these accepted electronic invitations for events may be included in the example GUI 345. The accepted electronic invitations for events may be for past, present and future events. The event information elements 350 may be selectable. Upon a selection or activation of one of the event information elements 350, additional information pertaining to the event may be presented in a GUI (not illustrated in FIG. 3E). The example GUI 345 may also display the event information elements 350 in a particular order, such a chronological, organized by date, time, etc.

FIGS. 4A, 4B, 4C, 4D, 4E illustrate example GUIs for initiating or creating an event. The example GUIs in FIGS. 4A, 4B, 4C, 4D, 4E may be generated and/or presented by the GUI generator 135 of FIG. 1.

FIG. 4A illustrates an example GUI 400 for creating an event. The example GUI 400 may include various selectable and configurable event parameters 405. The event parameters 405 may define various aspects of the event. Some or all of the event parameters 405 may be preset or selectable from a preset list of options. Not all of the event parameters 405 are needed to create an event. Example event parameters 405 include a type of event (e.g., a date, group date, group activity, “the more the merrier,” a task, a schedule, a service project, etc.), a start time for the event, an end time for the event, a location, a picture, etc. The example GUI 400 may also include a skip button that lets the event creator skip this step in the event creation flow. The example GUI 400 may also include a next button that advances the event creation flow to the next GUI.

FIG. 4B illustrates an example GUI 410 for selecting a threshold number of acceptances of electronic invitations for the event that may be received. The example GUI 410 may include an interface element 415 for the selection of available acceptances for the event. Any number of acceptances may be selected, including one, or many. In at least one embodiment, the threshold number of acceptances of electronic invitations may be fewer than the number of invitees who may have the option of accepting the electronic invitation for the event.

FIG. 4C illustrates an example GUI 420 for selecting invitation parameters 425 for the event. The invitation parameters 425 may define various aspects of the electronic invitation for the event. Some or all of the invitation parameters 425 may be preset or selectable from a preset list of options. Not all of the invitation parameters 425 are needed to create an event. An example invitation parameters 425 may include an expiration for the electronic invitation, which may include any time before and up until the event starts, or after the occurrence of any defined action. For example, the expiration of the electronic invitation may occur once all of the available acceptances are filled. At that point, the electronic invitation may not be presented to others. Other example invitation parameters 425 may include: who may receive or view the electronic invitation to the event (e.g., a friend, group/groups, everyone (i.e., public), a particular network, etc.), how invitees and/or attendees may see the invitation, or the event details after accepting an electronic invitation to attend the event (e.g., as a post in an application, a direct message, in a feed, inside an existing post, etc.), if there will be a group message or feed for others who have accepted the electronic invitation, whether other user may be invited to the event (e.g., a plus 1, 2, 3, etc.), whether or not other users can see who else was invited or was able to see the electronic invitation to the event, who can share the electronic invitation to the event, how others can share the electronic invitation to the event (e.g., allow other users to share with friends only, or allow other users to share with anyone including make it “public”, etc.), one or more hashtags to associate with the event, a picture, icon, reminders for the event, etc. The example GUI 400 may also include a skip button that lets the event creator skip this step in the event creation flow. The example GUI 400 may also include a next button that advances the event creation flow to the next GUI.

FIG. 4D illustrates an example GUI 430 for selecting invitees and how to send the electronic invitation for the event to the invitees. In at least one embodiment, the electronic invitation for the event may be set to “public” which may allow anyone to view and/or accept the electronic invitation for the event. The electronic invitation may also be more limited in its distribution to invitees. For example, the example GUI 430 may include a list of contacts 435 that may be selected. In at least one embodiment, the electronic invitation may be set to be sent to everyone except for any users that were selected in the list of contacts 435. Alternatively, the electronic invitation may be set to be sent to only those users that were selected in the list of contacts 435. In at least one embodiment, the example GUI 430 may include an invitee manager that may permit the event creator to select invitees from the list of contacts 435, including by searching for particular contacts. In at least one embodiment, the example GUI 430 may include a geography selection tool that allows the event creator to restrict invitees to invitees who are within a certain geographical range of any location (e.g., the current location of the event creator, a location selected by the event creator, a location of the event, etc.). For example, the event creator may select a 5 mile range such that the electronic invitation may be available (e.g., in a feed) to users within that 5 mile range. Once the event creator has selected one or more invitees to the event, the event creation flow may advance to the next step.

FIG. 4E illustrates an example GUI 440 of an electronic invitation preview 445. The electronic invitation preview 445 may be a preview of the electronic invitation, as it may be viewed by the invitees that were selected using the example GUI 430 of FIG. 4D. The example GUI 440 may include a back button to allow the event creator to go back to any of the example GUIs 400, 410, 410, or 430 to make any changes. The example GUI 440 may also include a send button that may initiate an event creation process and to cause electronic invitations to be sent to the invitees that were selected using the example GUI 430 of FIG. 4D. In at least one embodiment, in response to the send button being activated, the details of the event are sent to an event management platform (e.g., the event management platform 115 of FIG. 1).

FIGS. 5A, 5B, and 5C illustrate example GUIs for managing an event. The example GUIs in FIGS. 5A, 5B, and 5C may be generated and/or presented by the GUI generator 135 of FIG. 1.

FIG. 5A illustrates an example GUI 500 for managing invitees of an event. The example GUI 500 may permit an event creator to view the status of each invitee to the event. The example GUI 500 may include a list of invitees 505 that may have been invited to the event. The list of invitees 505 may include various information pertaining to the invitees, such as a read status, an acceptance status, whether the invitee has liked the event, whether the invitee has shared the event, whether the invitee has messaged others about the event, etc. Using the example GUI 500, the event creator may add or remove invitees for the event after the event has been created.

FIG. 5B illustrates an example GUI 510 for managing event parameters 515 and invitee parameters 520 for the event. Using the example GUI 510, the event creator may adjust any of the event parameters 515 and invitation parameters 520 for the event even after the event has been created, after one or all of the invitees has accepted the event, and after the threshold number of acceptances of the electronic invitation for the event has been met. The event parameters 515 may include any of the event parameters 405 of FIG. 4A. The invitation parameters 520 may include any of the invitation parameters of FIG. 4C.

FIG. 5C illustrates an example GUI 525 for an event messenger. The event messenger may present any number of messages 530 between the event creator and at least one of the invitees. In at least one embodiment, the example GUI 525 may include messages from all of the invitees who have accepted an electronic invitation to the event. In at least one embodiment, a separate example GUI 525 may be generated for each invitee such that the event creator and the respective invitee may exchange messages 530 in the example GUI 525.

FIGS. 6-9 illustrate flow diagrams of example methods related to an electronic event processing system. The methods may be performed by processing logic that may include hardware (circuitry, dedicated logic, etc.), software (such as is run on a general purpose computer system or a dedicated machine), or a combination of both, which processing logic may be included in the event organizer device 105, the event invitee device 110, and/or the event management platform 115 of FIG. 1, or another computer system or device. However, another system, or combination of systems, may be used to perform the methods. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a flow diagram of an example method 600 to create an event. The method 600 may begin at block 605, where processing logic may provide a graphical interface for creating an event. The graphical interface may include one or more interface elements configured to receive input pertaining to the event. The input pertaining to the event may include a threshold number of invitees that can accept an invitation to the event.

At block 610, the processing logic may receive, via the graphical interface, event input to create the event. The event input may include an invitee and the threshold number of invitees that can accept the invitation to the event. The event input may include a selection of an electronic delivery mechanism that includes a request to publish the invitation to the event in a news feed of first degree connections of an event organizer account in a social network. In at least one embodiment, the electronic delivery mechanism may include a set of parameters to restrict a presentation of the invitation to the event to first degree connections that meet the set of parameters. The event input may include an expiration time. After the expiration time, the invitation to the event may be prevented from being presented to invitee. The event input may include a selection of an image to include with the invitation to the event.

At block 615, the processing logic may cause an electronic invitation to the event to be sent to a client device associated with the invitee responsive to receiving the event input to create the event. In at least one embodiment, the processing logic may present a preview of the invitation to the event. The processing logic may also present, via the graphical interface, a confirmation button to create the event. The electronic invitation to the event may be sent in response to receiving an activation of the confirmation button.

At block 620, the processing logic may receive a notification indicative of an acceptance of the electronic invitation to the event. At block 625, the processing logic may determine whether the threshold number of invitees that can accept the invitation to the event has been met. In response to a determination that the threshold number of invitees that can accept the invitation to the event has not been met (“NO” at block 625), the processing logic may wait to receive a notification indicative of an acceptance of the electronic invitation to the event.

In response to a determination that the threshold number of invitees that can accept the invitation to the event has been met (“YES” at block 625), at block 630 the processing logic may display, via the graphical interface, that the threshold number of invitees have accepted the invitation to the event. In at least one embodiment, responsive to determining that the threshold number of invitees have accepted the invitation to the event, the invitation to the event may no longer be published in a news feed of first degree connections of an event organizer account in a social network.

At block 635, the processing logic may cause an electronic calendar meeting message to be sent to the invitee responsive to receiving the notification indicative of the acceptance of the electronic invitation to the event.

FIG. 7 illustrates a flow diagram of another example method 700 to handle a cancellation of an acceptance to an event. The method 700 may begin at block 705, where processing logic may receive a cancellation message from an invitee to rescind an acceptance of an electronic invitation to an event. In at least one embodiment, the processing logic may determine that a threshold number of invitees that can accept the electronic invitation to the event has not been met responsive to receiving the cancellation message.

At block 710, the processing logic may identify a second invitee. The second invitee may have received the electronic invitation previously. Alternatively, the second invitee may have not previously received or seen the electronic invitation.

At block 715, the processing logic may cause a second electronic invitation to the event to be sent to the second invitee. At block 720, the processing logic may receive a second notification indicative of a second acceptance of the electronic invitation to the event by the second invitee

At block 725, the processing logic may display, via the graphical interface, that the threshold number of invitees have accepted the invitation to the event in response to receiving the second notification indicative of the second acceptance of the electronic invitation to the event by the second invitee.

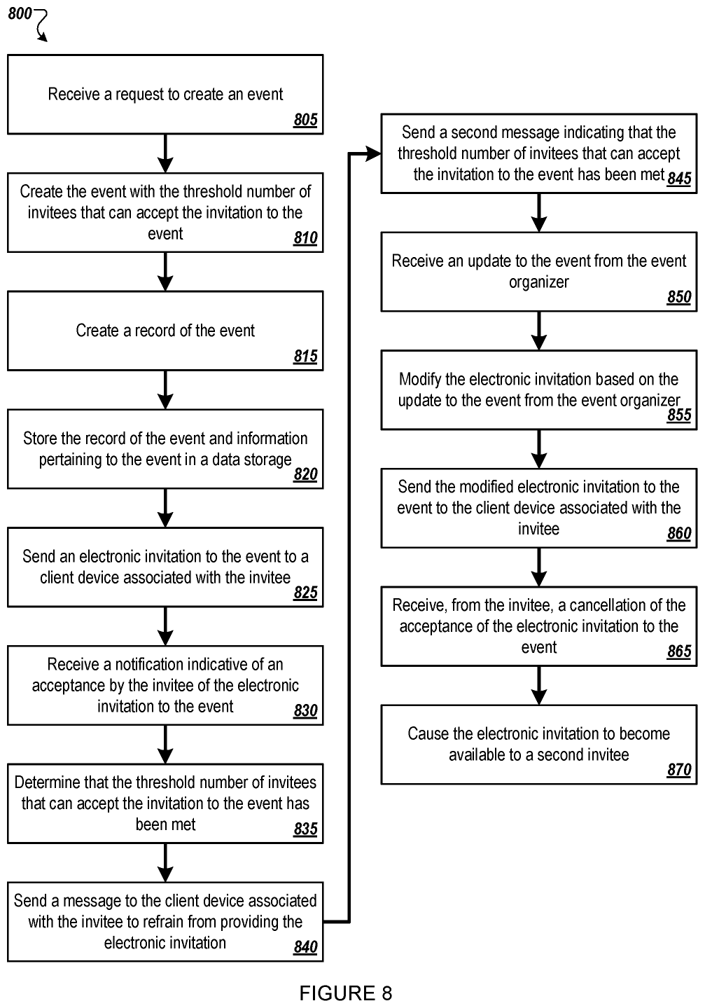

FIG. 8 illustrates a flow diagram of another example method 800 to handle a request to create an event. The method 800 may begin at block 805, where processing logic may receive a request to create an event. The request may include input pertaining to the event. The input pertaining to the event may include an invitee and a threshold number of invitees that can accept an invitation to the event.

At block 810, the processing logic may create the event with the threshold number of invitees that can accept the invitation to the event. At block 815, the processing logic may create a record of the event. At block 820, the processing logic may store the record of the event and information pertaining to the event in a data storage.

At block 825, the processing logic may send an electronic invitation to the event to a client device associated with the invitee. At block 830, the processing logic may receive a notification indicative of an acceptance by the invitee of the electronic invitation to the event. In at least one embodiment, the input pertaining to the event may include a plurality of invitees. The processing logic may send the electronic invitation to the event to a plurality of client devices associated with the plurality of invitees.

At block 835, the processing logic may determine that the threshold number of invitees that can accept the invitation to the event has been met. At block 840, the processing logic may send a message to the client device associated with the invitee to refrain from providing the electronic invitation.

At block 845, the processing logic may send a second message to a second client device associated with an event organizer. The second message may indicate that the threshold number of invitees that can accept the invitation to the event has been met.

At block 850, the processing logic may receive an update to the event from the event organizer. At block 855, the processing logic may modify the electronic invitation based on the update to the event from the event organizer. At block 860, the processing logic may send the modified electronic invitation to the event to the client device associated with the invitee.

At block 865, the processing logic may receive, from the invitee, a cancellation of the acceptance of the electronic invitation to the event. At block 870, the processing logic may cause the electronic invitation to become available again to the second invitee.

In an example, when a number of the plurality of invitees exceeds the threshold number of invitees that can accept the invitation to the event has been met, the processing logic may receive a number of acceptances to the event from a first set of the plurality of invitees. The number of acceptances to the event may be equal to the threshold number of invitees that can accept the invitation to the event. The processing logic may identify a second set of the plurality of invitees that includes all of the plurality of invitees that are not in the first set of the plurality of invitees. The processing logic may cause the electronic invitation to stop being available to the invitees in the second set of the plurality of invitees.

In at least one embodiment, when sending the electronic invitation to the event to the plurality of client devices associated with the plurality of invitees the processing logic may cause the electronic invitation to be presented in an available event section in a graphical interface associated with a mobile device application. In at least one embodiment, when causing the electronic invitation to stop being available to the invitees in the second set of the plurality of invitees, the processing logic may prevent the electronic invitation from being included in the available event section in the graphical interface associated with the mobile device application.

In at least one embodiment, when sending the electronic invitation to the event to the plurality of client devices associated with the plurality of invitees, the processing logic may cause the electronic invitation to be sent as a text-based message to the plurality of invitees. In at least one embodiment, when causing the electronic invitation to stop being available to the invitees in the second set of the plurality of invitees, the processing logic may cause the text-based message that includes the electronic invitation to disappear. The processing logic may receive, from the invitee, a cancellation of the acceptance of the electronic invitation to the event. The processing logic may cause the electronic invitation to become available again to the invitees in the second set of the plurality of invitees.

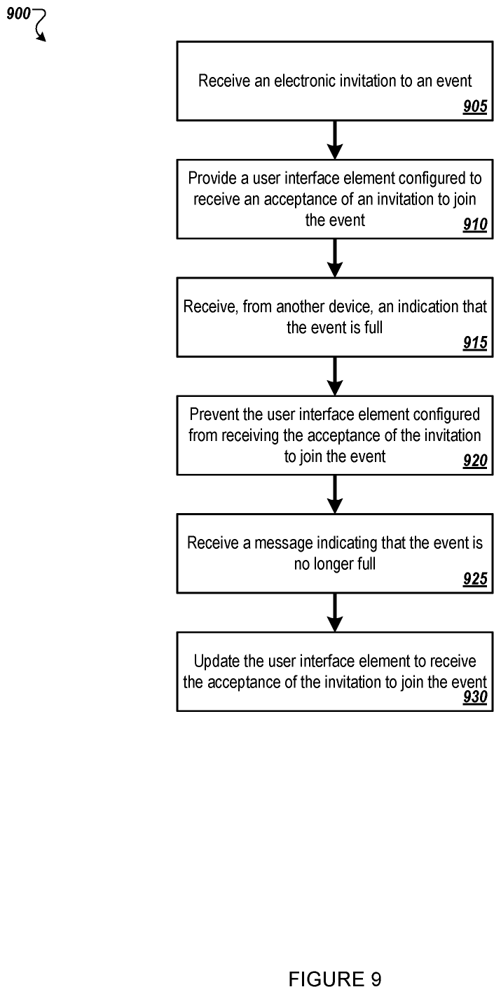

FIG. 9 illustrates a flow diagram of an example method 900 to receive an electronic invitation to an event. The method 900 may begin at block 905, where processing logic may receive an electronic invitation to an event.

At block 910, the processing logic may provide information pertaining to the event in a graphical interface. The information pertaining to the event may include a user interface element configured to receive an acceptance of an invitation to join the event.

At block 915, the processing logic may receive, from another device, an indication that the event is full. At block 920, the processing logic may prevent the user interface element from receiving the acceptance of the invitation to join the event.

At block 925, the processing logic may receive a message indicating that the event is no longer full. At block 930, the processing logic may update the user interface element to receive the acceptance of the invitation to join the event.

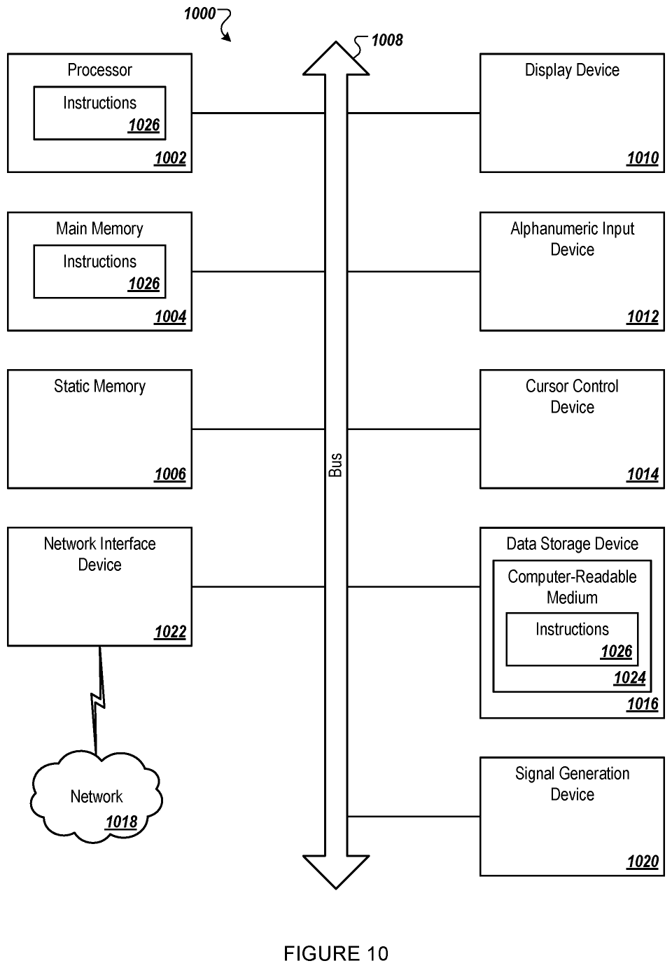

FIG. 10 illustrates a diagrammatic representation of a machine in the example form of a computing device 1000 within which a set of instructions, for causing the machine to perform any one or more of the methods discussed herein, may be executed. The computing device 1000 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 1000 includes a processing device (e.g., a processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1016, which communicate with each other via a bus 1008.

Processing device 1002 represents one or more processing devices such as a microprocessor, central processing unit, or the like. More particularly, the processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also include one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein.

The computing device 1000 may further include a network interface device 1022 which may communicate with a network 1018. The computing device 1000 also may include a display device 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1020 (e.g., a speaker). In at least one embodiment, the display device 1010, the alphanumeric input device 1012, and the cursor control device 1014 may be combined into a single component or device (e.g., an LCD touch screen).

The data storage device 1016 may include a computer-readable storage medium 1024 on which is stored one or more sets of instructions 1026 embodying any one or more of the methods or functions described herein. The instructions 1026 may also reside, completely or at least partially, within the main memory 1004 and/or within the processing device 1002 during execution thereof by the computing device 1000, the main memory 1004 and the processing device 1002 also constituting computer-readable media. The instructions may further be transmitted or received over a network 1018 via the network interface device 1022.

While the computer-readable storage medium 1026 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it may be understood that the various changes, substitutions, and alterations may be made hereto without departing from the spirit and scope of the present disclosure.

What is claimed is:

1. A system, comprising:
a memory; and
one or more processors communicatively coupled to the memory, the one or more processors being configured to execute operations to cause the system to perform operations comprising:
provide a graphical interface for creating an event, the graphical interface including one or more interface elements configured to receive input pertaining to the event, wherein the input pertaining to the event includes a threshold number of invitees that can accept an invitation to the event;
receive, via the graphical interface, event input to create the event, the event input including an invitee and the threshold number of invitees that can accept the invitation to the event;
responsive to receiving the event input to create the event, cause an electronic invitation to the event to be sent to a client device associated with the invitee;
receive a notification indicative of an acceptance of the electronic invitation to the event; and
display, via the graphical interface, that the threshold number of invitees have accepted the invitation to the event.

2. The system of claim 1, wherein execution of the operations further causes the system to cause an electronic calendar meeting message to be sent to the invitee responsive to receiving the notification indicative of the acceptance of the electronic invitation to the event.

3. The system of claim 1, wherein execution of the operations further causes the system to:
receive a cancellation message from the invitee to rescind the acceptance of the electronic invitation to the event;
determine that the threshold number of invitees that can accept the electronic invitation to the event has not been met responsive to receiving the cancellation message;
identify a second invitee;
cause a second electronic invitation to the event to be sent to the second invitee;
receive a second notification indicative of a second acceptance of the electronic invitation to the event by the second invitee; and
display, via the graphical interface, that the threshold number of invitees have accepted the invitation to the event in response to receiving the second notification indicative of the second acceptance of the electronic invitation to the event by the second invitee.

4. The system of claim 1, wherein the event input includes a selection of an electronic delivery mechanism that includes a request to publish the invitation to the event in a news feed of first degree connections of an event organizer account in a social network.

5. The system of claim 4, wherein responsive to determining that the threshold number of invitees have accepted the invitation to the event, the invitation to the event is no longer published in the news feed of the first degree connections of the event organizer account in the social network.

6. The system of claim 4, wherein the electronic delivery mechanism includes a set of parameters to restrict a presentation of the invitation to the event to first degree connections that meet the set of parameters.

7. The system of claim 1, wherein the event input includes an expiration time, wherein after the expiration time, the invitation to the event is prevented from being presented to invitee.

8. The system of claim 1, wherein the event input includes a selection of an image to include with the invitation to the event.

9. The system of claim 1, wherein execution of the operations further causes the system to:
present a preview of the invitation to the event; and
present, via the graphical interface, a confirmation button to create the event, wherein the electronic invitation to the event is sent in response to receiving an activation of the confirmation button.

10. A system, comprising:
a memory; and
one or more processors communicatively coupled to the memory, the one or more processors being configured to execute operations to cause the system to perform operations comprising:
receive a request to create an event, the request including input pertaining to the event, wherein the input pertaining to the event includes an invitee and a threshold number of invitees that can accept an invitation to the event;
create the event with the threshold number of invitees that can accept the invitation to the event;
create a record of the event;
store the record of the event and information pertaining to the event in a data storage;
send an electronic invitation to the event to a client device associated with the invitee;
receive a notification indicative of an acceptance by the invitee of the electronic invitation to the event;
determine that the threshold number of invitees that can accept the invitation to the event has been met; and
send a message to the client device associated with the invitee to refrain from providing the electronic invitation.

11. The system of claim 10, wherein execution of the operations further causes the system to send a second message to a second client device associated with an event organizer, the second message indicating that the threshold number of invitees that can accept the invitation to the event has been met.

12. The system of claim 11, wherein execution of the operations further causes the system to:
receive an update to the event from the event organizer;
modify the electronic invitation based on the update to the event from the event organizer; and
send the modified electronic invitation to the event to the client device associated with the invitee.

13. The system of claim 10, wherein the input pertaining to the event includes a plurality of invitees, wherein execution of the operations further causes the system to send the electronic invitation to the event to a plurality of client devices associated with the plurality of invitees.

14. The system of claim 13, wherein when a number of the plurality of invitees exceeds the threshold number of invitees that can accept the invitation to the event has been met, execution of the operations further causes the system to:
receive a number of acceptances to the event from a first set of the plurality of invitees, the number of acceptances to the event being equal to the threshold number of invitees that can accept the invitation to the event;
identify a second set of the plurality of invitees that includes all of the plurality of invitees that are not in the first set of the plurality of invitees; and
cause the electronic invitation to stop being available to the invitees in the second set of the plurality of invitees.

15. The system of claim 14, wherein sending the electronic invitation to the event to the plurality of client devices associated with the plurality of invitees includes causing the electronic invitation to be presented in an available event section in a graphical interface associated with a mobile device application, wherein causing the electronic invitation to stop being available to the invitees in the second set of the plurality of invitees includes preventing the electronic invitation from being included in the available event section in the graphical interface associated with the mobile device application.

16. The system of claim 14, wherein sending the electronic invitation to the event to the plurality of client devices associated with the plurality of invitees includes causing the electronic invitation to be sent as a text-based message to the plurality of invitees, wherein causing the electronic invitation to stop being available to the invitees in the second set of the plurality of invitees includes causing the text-based message that includes the electronic invitation to disappear.

17. The system of claim 14, wherein execution of the operations further causes the system to:
receive, from the invitee, a cancellation of the acceptance of the electronic invitation to the event; and
cause the electronic invitation to become available again to the invitees in the second set of the plurality of invitees.

18. The system of claim 10, wherein execution of the operations further causes the system to:
receive, from the invitee, a cancellation of the acceptance of the electronic invitation to the event;
identify a second invitee; and
send the electronic invitation to the event to the second invitee.

19. A system, comprising:
a memory; and
one or more processors communicatively coupled to the memory, the one or more processors being configured to execute operations to cause the system to perform operations comprising:
receive an electronic invitation to an event;
provide information pertaining to the event in a graphical interface, the information pertaining to the event including a user interface element configured to receive an acceptance of an invitation to join the event;
receive, from another device, an indication that the event is full; and
prevent the user interface element from receiving the acceptance of the invitation to join the event.

20. The system of claim 19, wherein execution of the operations further causes the system to:
receive a message indicating that the event is no longer full; and
update the user interface element to receive the acceptance of the invitation to join the event.
